(19) United States
(12) Patent Application Publication
(10) Pub. No.: US 2026/0194963 A1
(43) Pub. Date: Jul. 9, 2026

(54) CORE GROUPING IN PROCESSOR

(71) Applicant: Intel Corporation, Santa Clara, CA (US)

(72) Inventors: Jiang Yu, Shanghai (CN); Wenhui Shu, Shanghai (CN); Zhiming Li, Shanghai (CN); Xiaoguo Liang, Shanghai (CN); Youquan Song, Beijing (CN)

(21) Appl. No.: 19/130,519

(22) PCT Filed: Dec. 21, 2022
(86) PCT No.: PCT/CN2022/140555

§ 371 Date: May 15, 2025

(51) Int. Cl. G06F 1/3296

(52) U.S. Cl. CPC G06F 1/3296

(57) ABSTRACT

In an embodiment, a processor includes a plurality of cores and control circuitry. The control circuitry is to: detect a selection of a deep sleep mode to be entered by a first core of the processor; in response to the detection of the selection of the deep sleep mode, determine whether a total number of cores in a shallow sleep state is less than a minimum level of a shallow sleep group of the processor; and in response to a determination that the total number of cores in the shallow sleep state is less than the minimum level of the shallow sleep group, cause the first core to enter the shallow sleep mode instead of the selected deep sleep mode. Other embodiments are described and claimed.

### FIELD OF INVENTION

Embodiments relate generally to computer processors. More particularly, embodiments are related to power management in computer processors.

### BACKGROUND

Advances in semiconductor processing and logic design have permitted an increase in the amount of logic that may be present on integrated circuit devices. As a result, computer system configurations have evolved from a single or multiple integrated circuits in a system to multiple hardware threads, multiple cores, multiple devices, and/or complete systems on individual integrated circuits. Further, as the density of integrated circuits has grown, the power requirements for computing systems have also grown. As a result, there is a vital need for energy efficiency and conservation associated with integrated circuits.

### BRIEF DESCRIPTION OF THE DRAWINGS

FIG. 1 is a diagram of an example computing system, in accordance with one or more embodiments.

FIG. 2 is a diagram of an example processor with core(s), in accordance with one or more embodiments.

FIGS. 3A-3B are diagrams of example core architectures, in accordance with one or more embodiments.

FIG. 4 is a diagram of an example execution unit(s) circuitry, in accordance with one or more embodiments.

FIG. 5 is a diagram of an example register architecture, in accordance with one or more embodiments.

FIGS. 6A-6B are diagrams of example systems in accordance with one or more embodiments.

FIGS. 7A-7B are diagrams of example core groups, in accordance with one or more embodiments.

FIG. 8 is a flow diagram of an example method, in accordance with one or more embodiments.

FIG. 9 is a flow diagram of an example method, in accordance with one or more embodiments.

FIG. 10 is a diagram of example software components, in accordance with one or more embodiments.

FIG. 11 is a flow diagram of an example method, in accordance with one or more embodiments.

FIG. 12 is a diagram of an example storage medium, in accordance with one or more embodiments.

### DETAILED DESCRIPTION

Some computer processors may include multiple processing engines or “cores.” The cores may capable of operating in one of multiple power or sleep modes. For example, a core may operate in a shallow sleep mode that provides a relatively high level of functionality but a relatively low level of power savings. Further, a core may operate in a deep sleep mode that provides a relatively low level of functionality but a relatively high level of power savings. However, the deep sleep mode may require a relatively long latency time to restore full functionality (e.g., in comparison to the shallow sleep mode). Further, in some examples, such relatively long latency time may significantly impact the performance of the processor. As such, some users may disable the deep sleep mode of the processor to prevent the negative impact associated with this latency time. Accordingly, in such examples, the energy consumption of the processor may not be reduced by using the deep sleep state.

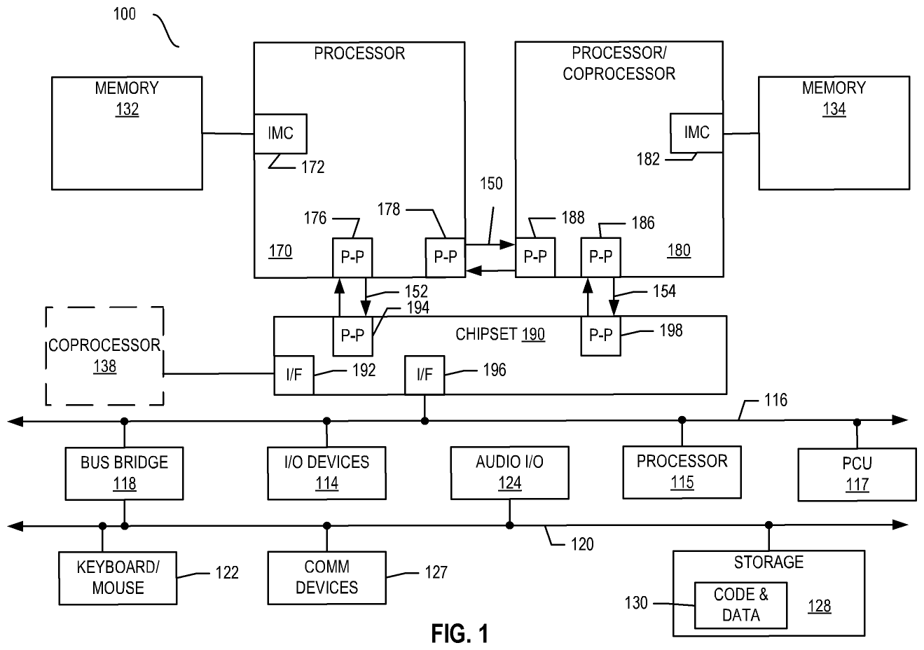

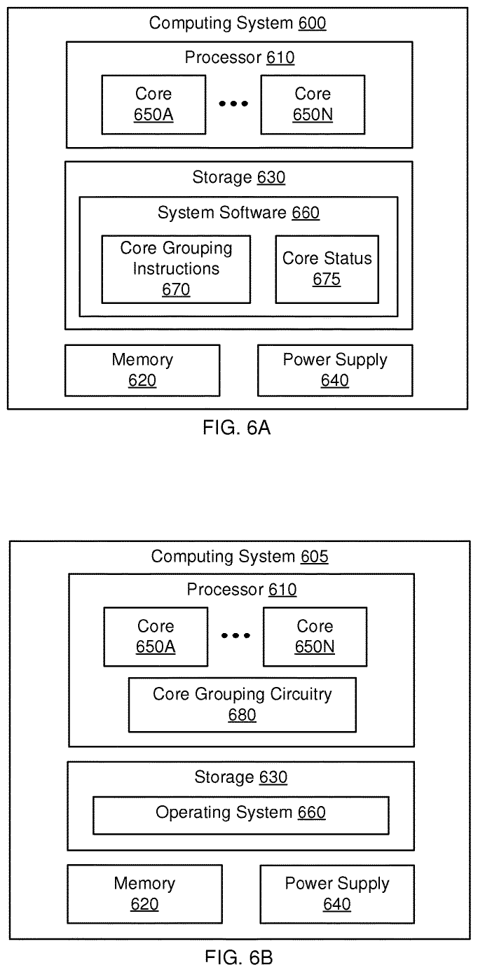

In accordance with one or more embodiments described herein, a processor may allocate cores of a processor into groups according to their respective operating mode. For example, the cores may be allocated into an active group, a shallow sleep group, and a deep sleep group. The processor may manage the core groups to attempt to maintain a minimum number of cores in the shallow sleep mode, and at least some cores in the deep sleep group. In this manner, the core grouping functionality may reduce the latency time to activate cores, while still providing at least some energy savings from the cores using the deep sleep mode. Accordingly, some embodiments may improve the performance and/or energy efficiency of the processor. Various details of some embodiments are described further below with reference to FIGS. 6A-12. Further, exemplary systems and architectures are described below with reference to FIGS. 1-5.

### Example Systems and Architectures

### FIG. 1—Example Computing System

FIG. 1 illustrates an example computing system. Multiprocessor system 100 is an interfaced system and includes a plurality of processors including a first processor 170 and a second processor 180 coupled via an interface 150 such as a point-to-point (P-P) interconnect, a fabric, and/or bus. In some examples, the first processor 170 and the second processor 180 are homogeneous. In some examples, first processor 170 and the second processor 180 are heterogenous. Though the example system 100 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 170 and 180 are shown including integrated memory controller (IMC) circuitry 172 and 182, respectively. Processor 170 also includes interface circuits 176 and 178, along with core sets. Similarly, second processor 180 includes interface circuits 186 and 188, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 170, 180 may exchange information via the interface 150 using interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a network interface (NW I/F) 190 via individual interfaces 152, 154 using interface circuits 176, 194, 186, 198. The network interface 190 (e.g., one or more of an interconnect, bus, and/or fabric, and in some examples is a chipset) may optionally exchange information with a coprocessor 138 via an interface circuit 192. In some examples, the coprocessor 138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 170, 180 or outside of both processors, yet connected with the processors via an interface such as P-P interconnect, such that either or both processors' local cache information may be stored in the shared cache if a processor is placed into a low power mode.

Network interface 190 may be coupled to a first interface 116 via interface circuit 196. In some examples, first interface 116 may be an interface such as a Peripheral Component Interconnect (PCI) interconnect, a PCI Express interconnect, or another I/O interconnect. In some examples, first interface 116 is coupled to a power control unit (PCU) 117, which may include circuitry, software, and/or firmware to perform power management operations with regard to the processors 170, 180 and/or co-processor 138. PCU 117 provides control information to one or more voltage regulators (not shown) to cause the voltage regulator(s) to generate the appropriate regulated voltage(s). PCU 117 also provides control information to control the operating voltage generated. In various examples, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other examples, power management operations to be performed by PCU 117 may be implemented externally to a processor, such as by way of a separate power management integrated circuit (PMIC) or another component external to the processor. In yet other examples, power management operations to be performed by PCU 117 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 114 may be coupled to first interface 116, along with a bus bridge 118 which couples first interface 116 to a second interface 120. In some examples, one or more additional processor(s) 115, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 116. In some examples, second interface 120 may be a low pin count (LPC) interface. Various devices may be coupled to second interface 120 including, for example, a keyboard and/or mouse 122, communication devices 127 and storage circuitry 128. Storage circuitry 128 may be one or more non-transitory machine-readable storage media as described below, such as a disk drive or other mass storage device which may include instructions/code and data 130 and may implement the storage ‘ISAB03 in some examples. Further, an audio I/O 124 may be coupled to second interface 120. Note that other architectures than the point-to-point architecture described above are possible. For example, instead of the point-to-point architecture, a system such as multiprocessor system 100 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

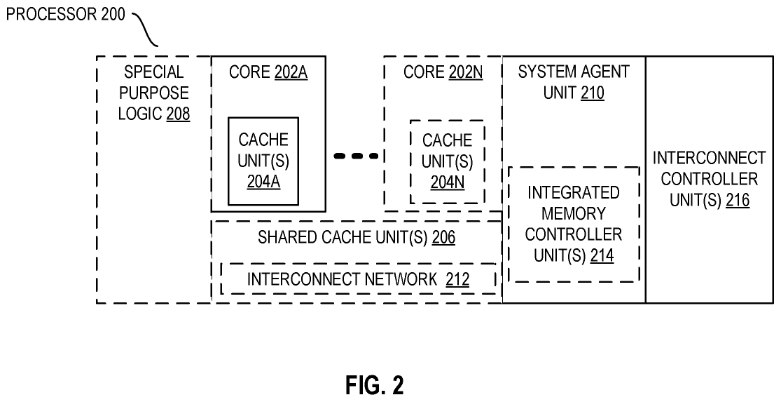

### FIG. 2—Example Processor with Core(s)

FIG. 2 illustrates a block diagram of an example processor and/or SoC 200 that may have one or more cores and an integrated memory controller. The solid lined boxes illustrate a processor 200 with a single core 202(A), system agent unit circuitry 210, and a set of one or more interface controller unit(s) circuitry 216, while the optional addition of the dashed lined boxes illustrates an alternative processor 200 with multiple cores 202(A)-(N), a set of one or more integrated memory controller unit(s) circuitry 214 in the system agent unit circuitry 210, and special purpose logic 208, as well as a set of one or more interface controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202(A)-(N) being one or more general purpose cores (e.g., general purpose in-order cores, general purpose out-of-order cores, or a combination of the two); 2) a coprocessor with the cores 202(A)-(N) being a large number of special purpose cores intended primarily for graphics and/or scientific (throughput); and 3) a coprocessor with the cores 202(A)-(N) being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including or more cores), embedded processor, or the like. The processor may be implemented on one or more chips. The processor 200 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 204(A)-(N) within the cores 202(A)-(N), a set of one or more shared cache unit(s) circuitry 206, and external memory (not shown) coupled to the set of integrated memory controller unit(s) circuitry 214. The set of one or more shared cache unit(s) circuitry 206 may include one or more mid-level caches, such as level 2 (L2), level 3 (L3), level 4 (L4), or other levels of cache, such as a last level cache (LLC), and/or combinations thereof. While in some examples interface network circuitry 212 (e.g., a ring interconnect) interfaces the special purpose logic 208 (e.g., integrated graphics logic), the set of shared cache unit(s) circuitry 206, and the system agent unit circuitry 210, alternative examples use any number of well-known techniques for interfacing such units. In some examples, coherency is maintained between one or more of the shared cache unit(s) circuitry 206 and cores 202(A)-(N). In some examples, interface controller units circuitry 216 couple the cores 202 to one or more other devices 218 such as one or more I/O devices, storage, one or more communication devices (e.g., wireless networking, wired networking, etc.), etc.

In some examples, one or more of the cores 202(A)-(N) are capable of multi-threading. The system agent unit circuitry 210 includes those components coordinating and operating cores 202(A)-(N). The system agent unit circuitry 210 may include, for example, power control unit (PCU) circuitry and/or display unit circuitry (not shown). The PCU may be or may include logic and components needed for regulating the power state of the cores 202(A)-(N) and/or the special purpose logic 208 (e.g., integrated graphics logic). The display unit circuitry is for driving one or more externally connected displays.

The cores 202(A)-(N) may be homogenous in terms of instruction set architecture (ISA). Alternatively, the cores 202(A)-(N) may be heterogeneous in terms of ISA; that is, a subset of the cores 202(A)-(N) may be capable of executing an ISA, while other cores may be capable of executing only a subset of that ISA or another ISA.

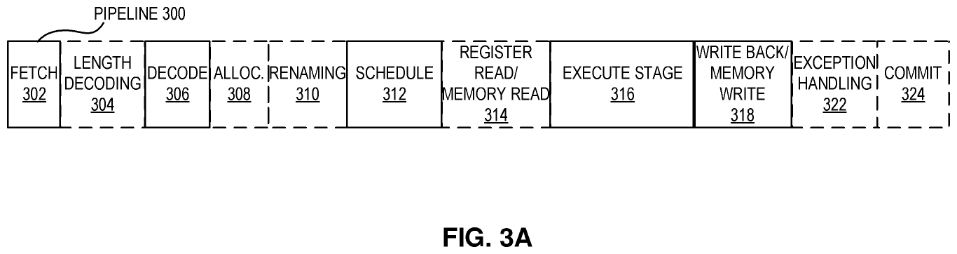

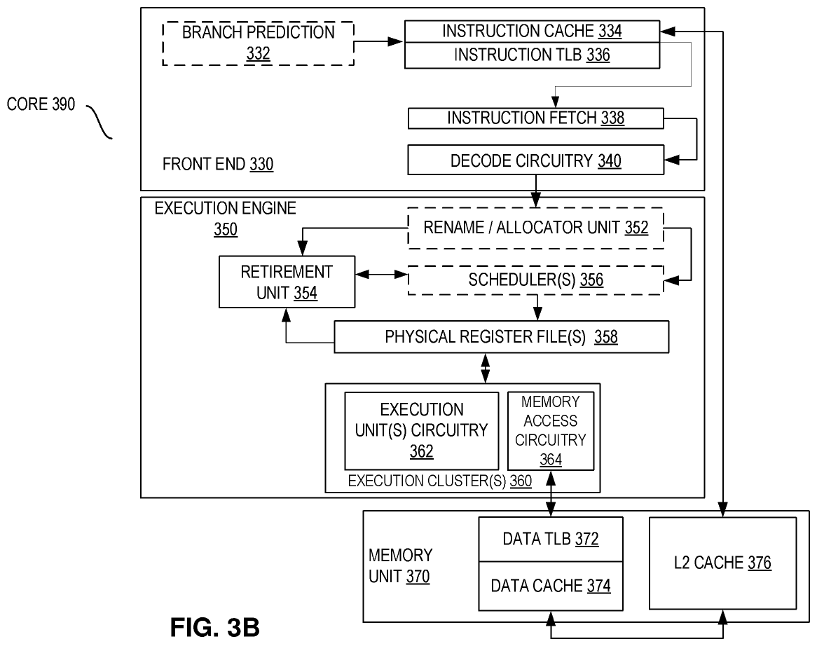

### FIGS. 3A-3B—Example Core Architectures

FIG. 3A is a block diagram illustrating both an example in-order pipeline and an example register renaming, out-of-order issue/execution pipeline according to examples. FIG. 3B is a block diagram illustrating both an example in-order architecture core and an example register renaming, out-of-order issue/execution architecture core to be included in a processor according to examples. The solid lined boxes in FIGS. 3A-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 3A, a processor pipeline 300 includes a fetch stage 302, an optional length decoding stage 304, a decode stage 306, an optional allocation (Alloc) stage 308, an optional renaming stage 310, a schedule (also known as a dispatch or issue) stage 312, an optional register read/memory read stage 314, an execute stage 316, a write back/memory write stage 318, an optional exception handling stage 322, and an optional commit stage 324. One or more operations can be performed in each of these processor pipeline stages. For example, during the fetch stage 302, one or more instructions are fetched from instruction memory, and during the decode stage 306, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 306 and the register read/memory read stage 314 may be combined into one pipeline stage. In one example, during the execute stage 316, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 3B may implement the pipeline 300 as follows: 1) the instruction fetch circuitry 338 performs the fetch and length decoding stages 302 and 304; 2) the decode circuitry 340 performs the decode stage 306; 3) the rename/allocator unit circuitry 352 performs the allocation stage 308 and renaming stage 310; 4) the scheduler(s) circuitry 356 performs the schedule stage 312; 5) the physical register file(s) circuitry 358 and the memory unit circuitry 370 perform the register read/memory read stage 314; the execution cluster(s) 360 perform the execute stage 316; 6) the memory unit circuitry 370 and the physical register file(s) circuitry 358 perform the write back/memory write stage 318; 7) various circuitry may be involved in the exception handling stage 322; and 8) the retirement unit circuitry 354 and the physical register file(s) circuitry 358 perform the commit stage 324.

FIG. 3B shows a processor core 390 including front-end unit circuitry 330 coupled to execution engine unit circuitry 350, and both are coupled to memory unit circuitry 370. The core 390 may be a reduced instruction set architecture computing (RISC) core, a complex instruction set architecture computing (CISC) core, a very long instruction word (VLIW) core, or a hybrid or alternative core type. As yet another option, the core 390 may be a special-purpose core, such as, for example, a network or communication core, compression engine, coprocessor core, general purpose computing graphics processing unit (GPGPU) core, graphics core, or the like.

The front-end unit circuitry 330 may include branch prediction circuitry 332 coupled to instruction cache circuitry 334, which is coupled to an instruction translation lookaside buffer (TLB) 336, which is coupled to instruction fetch circuitry 338, which is coupled to decode circuitry 340. In one example, the instruction cache circuitry 334 is included in the memory unit circuitry 370 rather than the front-end circuitry 330. The decode circuitry 340 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 340 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 340 may be implemented using various different mechanisms. Examples of suitable mechanisms include, but are not limited to, look-up tables, hardware implementations, programmable logic arrays (PLAs), microcode read only memories (ROMs), etc. In one example, the core 390 includes a microcode ROM (not shown) or other medium that stores microcode for certain macroinstructions (e.g., in decode circuitry 340 or otherwise within the front-end circuitry 330). In one example, the decode circuitry 340 includes a micro-operation (micro-op) or operation cache (not shown) to hold/cache decoded operations, micro-tags, or micro-operations generated during the decode or other stages of the processor pipeline 300. The decode circuitry 340 may be coupled to rename/allocator unit circuitry 352 in the execution engine circuitry 350.

The execution engine circuitry 350 includes the rename/allocator unit circuitry 352 coupled to retirement unit circuitry 354 and a set of one or more scheduler(s) circuitry 356. The scheduler(s) circuitry 356 represents any number of different schedulers, including reservations stations, central instruction window, etc. In some examples, the scheduler(s) circuitry 356 can include arithmetic logic unit (ALU) scheduler/scheduling circuitry, ALU queues, address generation unit (AGU) scheduler/scheduling circuitry, AGU queues, etc. The scheduler(s) circuitry 356 is coupled to the physical register file(s) circuitry 358. Each of the physical register file(s) circuitry 358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 358 includes vector registers unit circuitry, writemask registers unit circuitry, and scalar register unit circuitry. These register units may provide architectural vector registers, vector mask registers, general-purpose registers, etc. The physical register file(s) circuitry 358 is coupled to the retirement unit circuitry 354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 354 and the physical register file(s) circuitry 358 are coupled to the execution cluster(s) 360. The execution cluster(s) 360 includes a set of one or more execution unit(s) circuitry 362 and a set of one or more memory access circuitry 364. The execution unit(s) circuitry 362 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 356, physical register file(s) circuitry 358, and execution cluster(s) 360 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 364). It should also be understood that where separate pipelines are used, one or more of these pipelines may be out-of-order issue/execution and the rest in-order.

In some examples, the execution engine unit circuitry 350 may perform load store unit (LSU) address/data pipelining to an Advanced Microcontroller Bus (AMB) interface (not shown), and address phase and writeback, data phase load, store, and branches.

The set of memory access circuitry 364 is coupled to the memory unit circuitry 370, which includes data TLB circuitry 372 coupled to data cache circuitry 374 coupled to level 2 (L2) cache circuitry 376. In one example, the memory access circuitry 364 may include load unit circuitry, store address unit circuitry, and store data unit circuitry, each of which is coupled to the data TLB circuitry 372 in the memory unit circuitry 370. The instruction cache circuitry 334 is further coupled to the level 2 (L2) cache circuitry 376 in the memory unit circuitry 370. In one example, the instruction cache 334 and the data cache 374 are combined into a single instruction and data cache (not shown) in L2 cache circuitry 376, level 3 (L3) cache circuitry (not shown), and/or main memory. The L2 cache circuitry 376 is coupled to one or more other levels of cache and eventually to a main memory.

The core 390 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 390 includes logic to support a packed data instruction set architecture extension (e.g., AVX1, AVX2), thereby allowing the operations used by many multimedia applications to be performed using packed data.

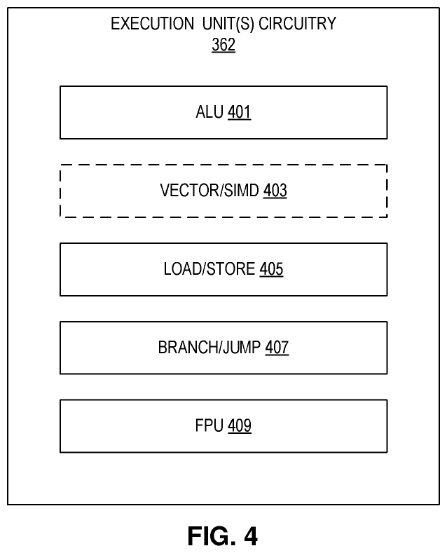

### FIG. 4—Example Execution Unit(s) Circuitry

FIG. 4 illustrates examples of execution unit(s) circuitry, such as execution unit(s) circuitry 362 of FIG. 3B. As illustrated, execution unit(s) circuitry 362 may include one or more ALU circuits 401, optional vector/single instruction multiple data (SIMD) circuits 403, load/store circuits 405, branch/jump circuits 407, and/or Floating-point unit (FPU) circuits 409. ALU circuits 401 perform integer arithmetic and/or Boolean operations. Vector/SIMD circuits 403 perform vector/SIMD operations on packed data (such as SIMD/vector registers). Load/store circuits 405 execute load and store instructions to load data from memory into registers or store from registers to memory. Load/store circuits 405 may also generate addresses. Branch/jump circuits 407 cause a branch or jump to a memory address depending on the instruction. FPU circuits 409 perform floating-point arithmetic. The width of the execution unit(s) circuitry 362 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

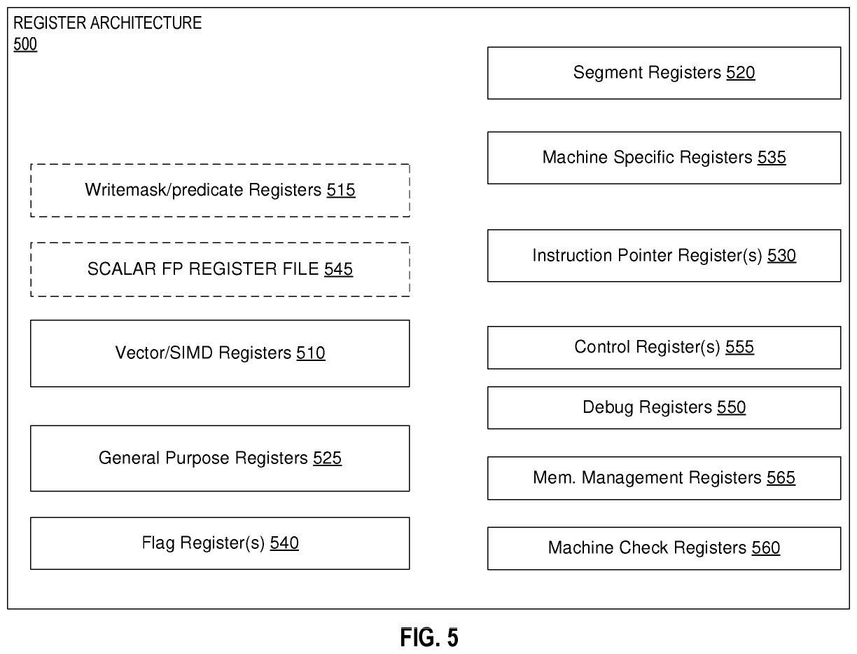

### FIG. 5—Example Register Architecture

FIG. 5 is a block diagram of a register architecture 500 according to some examples. As illustrated, the register architecture 500 includes vector/SIMD registers 510 that vary from 128-bit to 1,024 bits width. In some examples, the vector/SIMD registers 510 are physically 512-bits and, depending upon the mapping, only some of the lower bits are used. For example, in some examples, the vector/SIMD registers 510 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 500 includes writemask/predicate registers 515. For example, in some examples, there are 8 writemask/predicate registers (sometimes called k0 through k7) that are each 16-bit, 32-bit, 64-bit, or 128-bit in size. Writemask/predicate registers 515 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 515 corresponds to a data element position of the destination. In other examples, the writemask/predicate registers 515 are scalable and consists of a set number of enable bits for a given vector element (e.g., 8 enable bits per 64-bit vector element).

The register architecture 500 includes a plurality of general-purpose registers 525. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 500 includes scalar floating-point (FP) register file 545 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 540 (e.g., EFLAGS, RFLAGS, etc.) store status and control information for arithmetic, compare, and system operations. For example, the one or more flag registers 540 may store condition code information such as carry, parity, auxiliary carry, zero, sign, and overflow. In some examples, the one or more flag registers 540 are called program status and control registers.

Segment registers 520 contain segment points for use in accessing memory. In some examples, these registers are referenced by the names CS, DS, SS, ES, FS, and GS.

Machine specific registers (MSRs) 535 control and report on processor performance. Most MSRs 535 handle system-related functions and are not accessible to an application program. Machine check registers 560 consist of control, status, and error reporting MSRs that are used to detect and report on hardware errors.

One or more instruction pointer register(s) 530 store an instruction pointer value. Control register(s) 555 (e.g., CR0-CR4) determine the operating mode of a processor (e.g., processor 170, 180, 138, 115, and/or 200) and the characteristics of a currently executing task. Debug registers 550 control and allow for the monitoring of a processor or core's debugging operations.

Memory (mem) management registers 565 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 500 may, for example, be used in register file/memory, or physical register file(s) circuitry 358 (shown in FIG. 3B).

### Core Grouping in a Processor

### FIGS. 6A-6B—Example Computing Systems

FIG. 6A shows a block diagram of an example computing system 600, in accordance with one or more embodiments. In some embodiments, the computing system 600 may be all or a portion of a computing device. For example, the computing system 600 may be a cellular telephone, a computer, a server, a network device, a system on a chip (SoC), a controller, a distributed system, and so forth.

As shown in FIG. 6A, the computing system 600 may include a processor 610, memory 620, storage 630, and a power supply 640. Further, although not shown in FIG. 6A, the computing system 600 may include other components. The power supply 640 may provide electrical power to other components (e.g., processor 610, memory 620, storage 630).

In one or more embodiments, the memory 620 can be implemented with any type(s) of computer memory (e.g., dynamic random-access memory (DRAM), static random-access memory (SRAM), non-volatile memory (NVM), a combination of DRAM and NVM, etc.). In some embodiments, the storage 630 may include non-transitory storage media such as hard drives, flash storage, optical disks, etc. The storage 630 may store system software 660 (e.g., operating system, drivers, power management code, and so forth).

In one or more embodiments, the processor 610 may be a hardware processing device (e.g., a central processing unit (CPU), a System on a Chip (SoC), and so forth). As shown, the processor 610 can include any number of cores 650A-650N (also referred to herein as “cores 650” or “processing engines 650”). In some embodiments, the cores 650 may include multiple types of processing engines and/or other computing resources (e.g., graphics processing engine(s), math processing engines, encryption processing engines, network processing engines, memory devices, network devices, storage devices, bus devices, and so forth). Further, in some embodiments, the cores 650 may include general-purpose hardware processing engines.

In some embodiments, the cores 650 may capable of operating in one of multiple sleep modes. Each sleep mode may correspond to a particular combination of reduced levels of functionality and/or power consumption in comparison to an “awake” or active operating mode. For example, in some embodiments, a core 650 may operate in a “shallow” sleep mode, meaning a sleep mode which has a relatively low level of power savings, but which maintains a relatively high level of functionality, or which may require a relatively short time to restore full functionality. Further, the core 650 may operate in a “deep” sleep mode, meaning a sleep mode which has a relatively high level of power savings, but which maintains a relatively low level of functionality, or which may require a relatively long time to restore full functionality. Furthermore, in some embodiments, the core 650 may operate in other sleep modes having levels of functionality and/or power savings between those of the shallow sleep mode and the deep sleep mode (e.g., a “medium” sleep mode, a “medium-shallow” sleep mode, a “medium-deep” sleep mode, etc.). In some embodiments, the power states of the cores 650 may be in accordance with the Advanced Configuration and Power Interface (ACPI) standard (e.g., Rev. 3.0b, published Oct. 10, 2006). For example, the operating mode of a core 650 may be a C0 state, a shallow sleep mode of the core 650 may be a C1 state, and a deep sleep mode of the core 650 may be a state deeper than a C1 state (e.g., C1E, C6, and so forth).

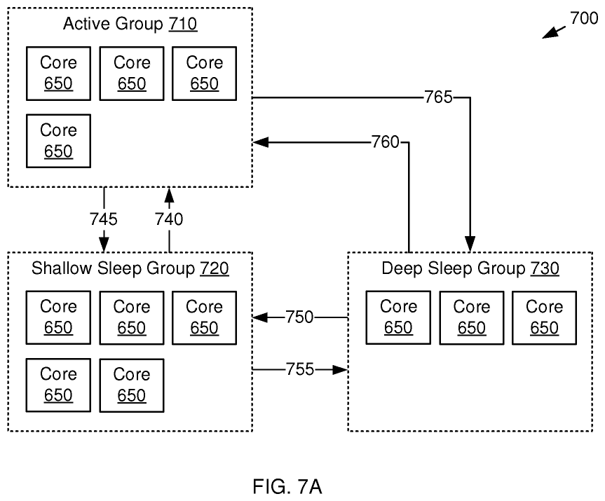

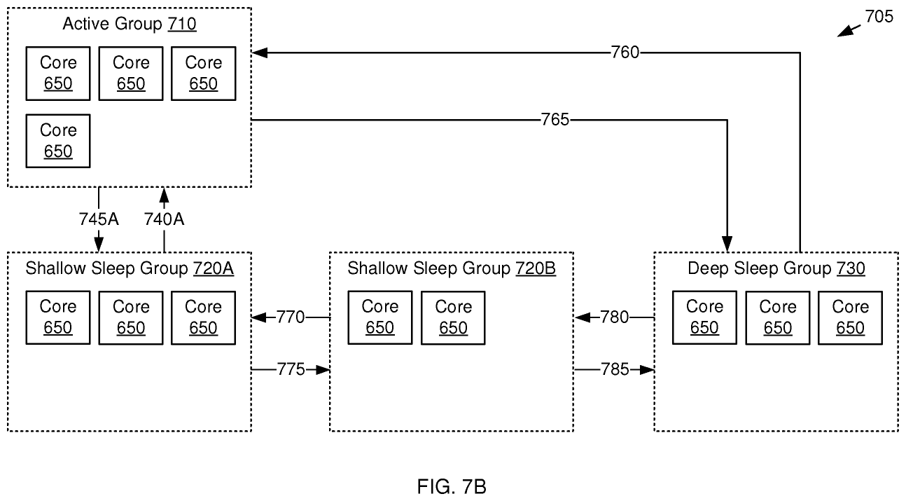

In one or more embodiments, the system software 660 may include core grouping instructions 670 and a core status structure 675. The core grouping instructions 670 may control the operating modes of the cores 650 (e.g., active mode, shallow sleep mode, deep sleep mode, and so forth). Further, the core grouping instructions 670 may allocate the cores 650 into groups according to their respective operating modes, and may store these allocations in the core status structure 675. For example, the core grouping instructions 670 may allocate the cores 650 among an active group, a shallow sleep group, and a deep sleep group. Some example embodiments of such core groups are discussed below with reference to FIGS. 7A-7B.

In one or more embodiments, the core grouping instructions 670 may allocate the cores 650 may manage the core groups to attempt to maintain a minimum number of cores in the shallow sleep mode, and at least some cores in the deep sleep group. In this manner, the core grouping instructions 670 may reduce the latency time to activate the cores 650, while still providing at least some energy savings from cores 650 using the deep sleep mode. Accordingly, the core grouping instructions 670 may improve the performance and/or energy efficiency of the processor 610.

In some implementations, the core status structure 675 may be a data structure to store information regarding the cores 650 and their allocated mode groups. For example, the core status structure 675 may be a table including multiple entries, with each entry including the identifier of a different core 650 and the identifier of one of an active group, a shallow sleep group, and a deep sleep group. In other embodiments, the core status structure 675 may be implemented as a bit array, with bit positions identifying the cores 650, and with the bit values indicating the corresponding operating mode of each core 650. Other implementations are possible.

In some embodiments, the core grouping instructions 670 may detect a request for a new active core 650 (e.g., to execute an upcoming processing load), and in response may cause a particular core 650 in a shallow sleep mode to transition to the active mode. The core grouping instructions 670 may also transfer the particular core 650 from the shallow sleep group to the active group, and may update the core status structure 675 to indicate this transfer.

In some embodiments, the core grouping instructions 670 may determine whether the number of cores 650 in the shallow sleep group is less than a minimum level. If so, the core grouping instructions 670 may transfer one or more cores from the deep sleep group to the shallow sleep group, thereby causing the number of cores 650 in the shallow sleep group to meet or exceed the minimum level. Further, the core grouping instructions 670 may update the core status structure 675 to indicate this transfer. As used herein, the term “shallow group count” may refer to the total quantity of cores 650 that are current assigned to the shallow sleep group.

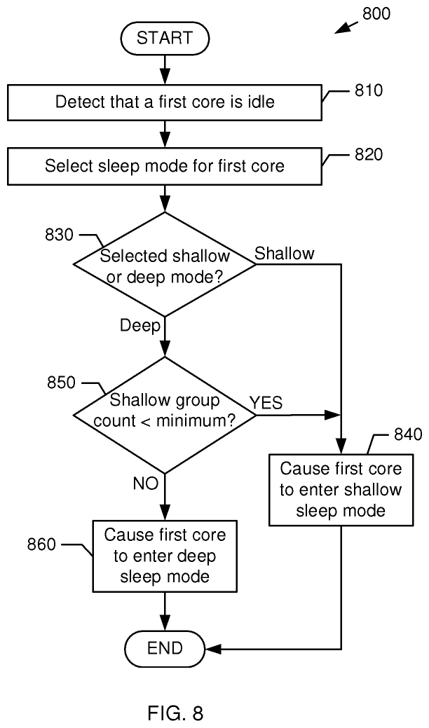

In some embodiments, the core grouping instructions 670 may detect that an active core 650 is idle (e.g., after completing a processing load), and in response may cause that active core 650 to transition to a shallow sleep mode. The core grouping instructions 670 may also transfer the active core 650 from the active group to the shallow sleep group, and may update the core status structure 675 to indicate this transfer. Alternatively, in some examples, the core grouping instructions 670 may cause the active core 650 to transition to a deep sleep mode, and may transfer the active core 650 to the deep sleep group. Some example core grouping methods are discussed below with reference to FIGS. 8-11.

Note that, while FIG. 6A illustrates an example embodiment in which the core grouping functionality is implemented as instructions 670, embodiments are not limited in this regard. For example, referring now to FIG. 6B, shown is an example computing system 605 in which the functionality described above with reference to the core grouping instructions 670 and the core status structure 675 is instead implemented in the core grouping circuitry 680 included in the processor 610. Further, while not shown in FIG. 6A-6B, it is contemplated that the aforementioned core grouping functionality may be implemented in other software and/or hardware of the computing systems 600, 605. Other embodiments are possible.

### FIGS. 7A-7B—Example Core Groups

FIG. 7A illustrates a first set 700 of core groups, in accordance with one or more embodiments. In some embodiments, the first set 700 may be generated and maintained by the core grouping instructions 670 (shown in FIG. 6A), by the core grouping circuitry 680 (shown in FIG. 6B).

As shown in FIG. 7A, the first set 700 may include an active group 710, a shallow sleep group 720, and a deep sleep group 730. The active group 710 may include each core 650 (e.g., in processor 610 shown in FIGS. 6A-6B) that is currently using an active operating mode (e.g., a C0 state). Further, the shallow sleep group 720 may include each core 650 that is currently using a shallow sleep mode (e.g., a C1 state), and the deep sleep group 730 may include each core 650 that is currently using a deep sleep mode (e.g., a sleep state deeper than C1, such as C1E, C2, C6, and so forth). In some implementations, a core status data structure (e.g., core status structure 675 shown in FIG. 6A) may store information regarding the cores 650 and their assigned groups. For example, a core status structure may be a table including multiple entries, with each entry including the identifier of a different core 650 and the identifier of the group 710, 720, 730 to which it is currently allocated.

In some embodiments, the cores 650 in the active group 710 may support a current workload of the processor. Subsequently, when an additional workload is expected or scheduled for the processor, a core 650 (or multiple cores 650) may be activated (i.e., transitioned to the active mode) to handle the additional workload. In some embodiments, the activated core 650 may be transitioned from the shallow sleep mode to the active mode. Further, as shown in FIG. 7A, that core 650 may be transferred 740 from the shallow sleep group 720 to the active group 710. Furthermore, in some examples, the activated core 650 may be transitioned from the deep sleep mode to the active mode, and the core 650 may be transferred 760 from the deep sleep group 730 directly to the active group 710. For example, the activated core 650 may be transitioned from the deep sleep mode to the active mode if the shallow sleep group 720 is currently empty.

In some embodiments, when the workload of the processor is reduced, the number of cores 650 in the active group 710 may be reduced accordingly. For example, a core 650 (or multiple cores 650) may be transitioned from the active mode to the shallow sleep mode, and that core 650 may be transferred 745 from the active group 710 to the shallow sleep group 720. Further, in some examples, the core 650 may be transitioned from the active mode to the deep sleep mode, and that core 650 may be transferred 765 from the active group 710 directly to the deep sleep group 730. In some embodiments, a core 650 may selected for the transfer 765 (e.g., from the active group 710 to the deep sleep group 730) if that core 650 is predicted to remain idle for a relatively long time (e.g., in comparison to other cores 650 of the processor). For example, the predicted idle time of the core 650 may be based on historical information regarding the past level of active use (or idleness) of that core 650. Further, if a different core 650 is predicted to remain idle for a relatively short time, that core 650 may selected for the transfer 745 (e.g., from the active group 710 to the shallow sleep group 720).

In some embodiments, if the number of cores 650 in the shallow sleep group 720 drops below a minimum level, at least one action may be performed to increase the number of cores 650 in the shallow sleep group 720 to reach or exceed the minimum level. For example, if the deep sleep group 630 is not empty, a core 650 (or multiple cores 650) may be transitioned from the deep sleep mode to the shallow sleep mode, and that core 650 may be transferred 750 from the deep sleep group 730 to the shallow sleep group 720. In some embodiments, the minimum level of the shallow sleep group 720 may be specified by a configuration setting, a user selection, and so forth. Further, in some embodiments, the minimum level of the shallow sleep group 720 may be adjusted during operation (e.g., by the core grouping instructions 670) based on system metrics or characteristics (e.g., history of active/idle times for each core 650, latency times to transition to active mode, proportion of idle time, and so forth).

In some embodiments, if the shallow group count (i.e., the number of cores 650 in the shallow sleep group 720) exceeds a predefined filled level, at least one action may be performed to decrease the number of cores 650 in the shallow sleep group 720. For example, when the workload of the processor is reduced, a core 650 may be transitioned from the active mode to a shallow sleep mode, thereby increasing the number of cores 650 in the shallow sleep group 720. Further, if the shallow sleep group 720 reaches a predefined filled capacity (e.g., 80% full, 100% full, etc.), a core 650 (or multiple cores 650) may be transitioned from the shallow sleep mode to the deep sleep mode, and that core 650 may be transferred 755 from the shallow sleep group 720 to the deep sleep group 730. In some embodiments, the predefined filled level of the shallow sleep group 720 may be specified by a configuration setting, a user selection, and so forth. Further, in some embodiments, the predefined filled level of the shallow sleep group 720 may be adjusted during operation (e.g., by the core grouping instructions 670) based on system metrics or characteristics (e.g., history of active/idle times for each core 650, latency times to transition to active mode, proportion of idle time, and so forth).

In some embodiments, use of the shallow sleep group 720 and the deep sleep group 730 may provide control over the number of cores 650 in shallow and deep sleep modes under different operating conditions. For example, some embodiments may allow a number of cores 650 to be kept in a shallow sleep mode to reduce the latency time when a core 650 is to be to activated, while allow keeping at least some cores 650 in the deep sleep mode to reduce energy consumption of the processor 610. In this manner, some embodiments may improve the performance and/or enerfy efficiency of the processor 610

Referring now to FIG. 7B, shown is a second set 705 of core groups, in accordance with one or more embodiments. In some embodiments, the second set 705 may be generated and maintained by the core grouping instructions 670 (shown in FIG. 6A), by the core grouping circuitry 680 (shown in FIG. 6B).

As shown in FIG. 7B, the second set 705 may include an active group 710, a first shallow sleep group 720A, a second shallow sleep group 720B, and a deep sleep group 730. The active group 710 may include each core 650 that is currently using an active operating mode (e.g., a C0 state). Further, the first shallow sleep group 720A may include each core 650 that is currently using a first shallow sleep mode (e.g., a C1 state), and the second shallow sleep group 720B may include each core 650 that is currently using a second shallow sleep mode that is deeper than the first shallow sleep mode (e.g., a C1E state). Furthermore, the deep sleep group 730 may include each core 650 that is currently using a deep sleep mode (e.g., a sleep state deeper than C1E, such as C2, C6, and so forth).

In some embodiments, when an additional workload is expected or scheduled for the processor, a core 650 may be transitioned from the first shallow sleep mode to the active mode, and that core 650 may be transferred 740A from the first shallow sleep group 720A to the active group 710. Further, when the workload of the processor is reduced, a core 650 may be transitioned from the active mode to the first shallow sleep mode, and that core 650 may be transferred 745A from the active group 710 to the first shallow sleep group 720A.

In some embodiments, if the number of cores 650 in the first shallow sleep group 720A drops below a first minimum level, a core 650 (or multiple cores 650) may be transitioned from the second shallow sleep mode to the first shallow sleep mode, and that core 650 may be transferred 770 from the second shallow sleep group 720B to the first shallow sleep group 720A. Similarly, if the number of cores 650 in the second shallow sleep group 720B drops below a second minimum level, a core 650 (or multiple cores 650) may be transitioned from the deep sleep mode to the second shallow sleep mode, and that core 650 may be transferred 780 from the deep sleep group 730 to the second shallow sleep group 720B.

In some embodiments, if the number of cores 650 in the first shallow sleep group 720A exceeds a first fill level (e.g., 80% full, 100% full, etc.), a core 650 (or multiple cores 650) may be transitioned from the first shallow sleep mode to the second shallow sleep mode, and that core 650 may be transferred 775 from the first shallow sleep group 720A to the second shallow sleep group 720B. Similarly, if the number of cores 650 in the second shallow sleep group 720B exceeds a second fill level, a core 650 (or multiple cores 650) may be transitioned from the second shallow sleep mode to the deep sleep mode, and that core 650 may be transferred 785 from the second shallow sleep group 720B to the deep sleep group 730.

### FIG. 8—Example Method

FIG. 8 shows a flow diagram of an example method 800 for controlling sleep modes, in accordance with one or more embodiments. In various embodiments, the method 800 may be performed by processing logic that may include hardware (e.g., processing device, circuitry, dedicated logic, programmable logic, microcode, etc.), software (e.g., instructions run on a processing device), or a combination thereof. For example, the method 800 may be performed by the core grouping instructions 670 (shown in FIG. 6A), by the core grouping circuitry 680 (shown in FIG. 6B), and so forth. In firmware or software embodiments, the method 800 may be implemented by computer executed instructions stored in a non-transitory machine readable medium, such as an optical, semiconductor, or magnetic storage device. The machine-readable medium may store data, which if used by at least one machine, causes the at least one machine to fabricate at least one integrated circuit to perform a method. For the sake of illustration, the actions involved in the method 800 may be described below with reference to FIGS. 6A-7A, which show examples in accordance with one or more embodiments. However, the scope of the various embodiments discussed herein is not limited in this regard.

Block 810 may include detecting that a first core is idle. Block 820 may include selecting a sleep mode for first core. Decision block 830 may include determining whether the selection is a shallow sleep mode or a deep sleep mode. If the selection is a shallow sleep mode, then the method 800 may continue at block 840, including causing the first core to enter the shallow sleep mode. After block 840, the method 800 may be completed.

For example, referring to FIGS. 6A and 7A, the system software 660 (including core grouping instructions 670) detects that an active core 650A has completed its assigned workload, and then sends an idle signal or message to indicate that the workload has been completed. The system software 660 receives the idle signal, and then selects a sleep mode for the core 650A (e.g., based on the expected workload for core 650A, the past usage/idle history of core 650A, the workloads and/or states of other cores 650, and so forth). If the selected sleep mode is the shallow sleep mode, the system software 660 causes the core 650A to transition from an active mode (e.g., a C0 state to the selected shallow sleep mode (e.g., a C1 state). Further, the core status structure 675 is updated to indicate that the core 650A is transferred 745 from the active group 710 to the shallow sleep group 720.

Referring again to FIG. 8, if it is instead determined at decision block 830 that the selection is a deep sleep mode (e.g., a C6 state), then the method 800 may continue at decision block 850, including determining whether the shallow group count is less than a minimum level. If so (“YES”), then the method 800 may continue at block 840 (described above). Otherwise, if the shallow group count is not less than the minimum level (“NO”), then then the method 800 may continue at block 860, including causing the first core to enter the deep sleep mode. After block 860, the method 800 may be completed.

For example, referring to FIGS. 6A and 7A, the system software 660 (including core grouping instructions 670) determines that the selected sleep mode is a deep sleep mode, and in response determines whether the shallow group count (i.e., the number of cores 650 in the shallow sleep group 720) is less than a minimum level that is predefined for the shallow sleep group 720. If the shallow group count is less than the minimum level (“YES”), then the system software 660 causes the core 650A to transition from the active mode to the shallow sleep mode (i.e., instead of the selected deep sleep mode), and updates the core status structure 675 to indicate that the core 650A is transferred 745 from the active group 710 to the shallow sleep group 720. Stated differently, if the count of the shallow sleep group 720 is too low (e.g., below a predefined minimum level), the core 650A is not transferred to the deep sleep group 730 (per the initial selection) and instead is added to the shallow sleep group 720, and may thereby increase the count of the shallow sleep group 720 above (or closer to) the minimum level. Otherwise, if the shallow group count is not less than the minimum level, the system software 660 causes the core 650A to transition from the active mode to the deep sleep mode (as initially selected), and updates the core status structure 675 to indicate that the core 650A is transferred 765 from the active group 710 to the deep sleep group 730.

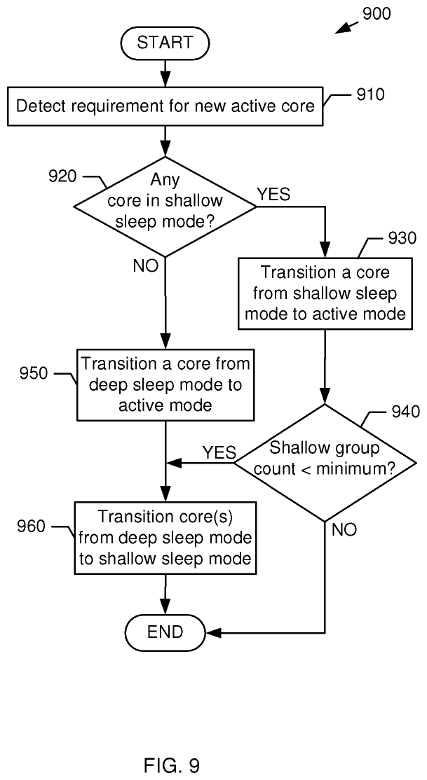

### FIG. 9—Example Method

FIG. 9 shows a flow diagram of an example method 900 for controlling sleep modes, in accordance with one or more embodiments. In various embodiments, the method 900 may be performed by processing logic that may include hardware (e.g., processing device, circuitry, dedicated logic, programmable logic, microcode, etc.), software (e.g., instructions run on a processing device), or a combination thereof. For example, the method 900 may be performed by the core grouping instructions 670 (shown in FIG. 6A), by the core grouping circuitry 680 (shown in FIG. 6B), and so forth. In firmware or software embodiments, the method 900 may be implemented by computer executed instructions stored in a non-transitory machine readable medium, such as an optical, semiconductor, or magnetic storage device. The machine-readable medium may store data, which if used by at least one machine, causes the at least one machine to fabricate at least one integrated circuit to perform a method. For the sake of illustration, the actions involved in the method 900 may be described below with reference to FIGS. 6A-7B, which show examples in accordance with one or more embodiments. However, the scope of the various embodiments discussed herein is not limited in this regard.

Block 910 may include detecting a requirement for a new active core. Decision block 920 may include determining whether any core(s) are currently in a shallow sleep mode. If not (“NO”), the method 900 may continue at block 950, including transitioning a core from a deep sleep mode to an active mode. After block 950, the method 900 may continue at block 960 (described below). However, if it is determined at decision block 920 that there is currently at least one core in the shallow sleep mode (“YES”), then the method 900 may continue at block 930, including transitioning a core from the shallow sleep mode to the active mode.

For example, referring to FIGS. 6A and 7A, the system software 660 (including core grouping instructions 670) detects that the workload of the processor 610 is expected to increase, and thus there is a need or requirement to activate a core 650 to handle the increased workload. If there is currently at least one core 650 in the shallow sleep mode (e.g., C1 state), that core 650 is transitioned to the active mode (e.g., C0 state), and is also transferred 740 from the shallow sleep group 720 to the active group 710. However, if there are no cores 650 in the shallow sleep mode, a core 650 is transitioned from the deep sleep mode to the active mode, and is also transferred 760 from the deep sleep group 730 to the active group 710.

Referring again to FIG. 9, after block 930, the method 900 may continue at decision block 940, including determining whether the shallow group count is below a minimum level. If not (“NO”), then the method 900 may be completed. However, if it is determined that the shallow group count is below the minimum level (“YES”), then the method 900 may continue at block 960, including transition one or more cores from the deep sleep mode to the shallow sleep mode. After block 960, the method 900 may be completed.

For example, referring to FIGS. 6A and 7A, the system software 660 (including core grouping instructions 670) determines that the number of cores 650 in the shallow sleep group 720 is below a minimum level, and in response causes at least one core 650 to be transitioned from the deep sleep mode to the shallow sleep mode. Further, the at least one core 650 is transferred 760 from the deep sleep group 730 to the shallow sleep group 720. In this manner, the count of the shallow sleep group 720 may be increased above (or closer to) the minimum level.

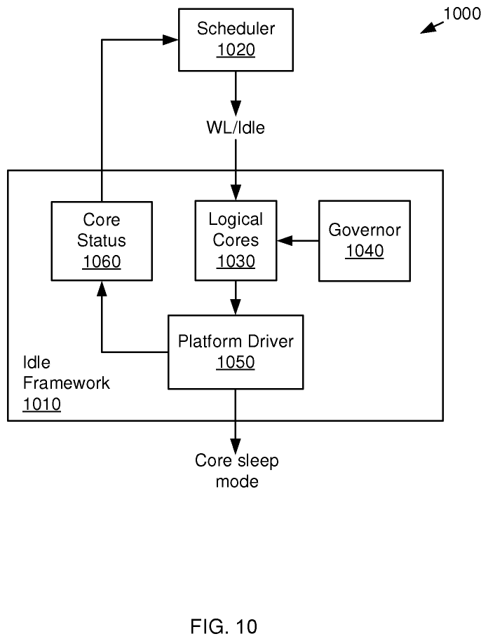

### FIG. 10—Example Software Components

FIG. 10 illustrates an example system 1000 of software components, in accordance with one or more embodiments. The system 1000 may correspond generally to an example implementation of some or all of the system software 660 (shown in FIG. 6A).

As shown in FIG. 10, the system 1000 may include a scheduler 1020 and an idle framework 1010. The scheduler 1020 may be a software module that assigns workloads or idle periods to a processor (e.g., processor 610 shown in FIG. 6A). The idle framework 1010 may be software component(s) of an operating system to control the idle or sleep modes of cores of the processor. In some embodiments, the idle framework 1010 may include logical cores 1030, a governor 1040, platform driver 1050, and a core status structure 1060.

In some embodiments, the logical cores 1030 may be abstractions that represent cores of a processor. The governor 1040 may select a sleep mode for a logical core 1030 (e.g., based on historical or recent execution data). The platform driver 1050 may a software driver (e.g., an idle driver) to control sleep modes (e.g., idle states) in components of a processor. In some embodiments, the platform driver 1050 may include core grouping logic (e.g., the core grouping instructions 670 shown in FIG. 6A). However, in other embodiments, the core grouping logic may be implemented in any other component of the system 1000. (e.g., in governor 1040, in scheduler 1020, and so forth).

In some embodiments, when a core becomes idle, the governor 1040 may determine a sleep mode that it should enter. If the governor 1040 selects a shallow sleep mode (e.g., a C1 state), it causes (via the logical core 1030 and the platform driver 1050) the core to enter the shallow sleep mode. However, if the governor 1040 selects a deep sleep mode, the platform driver 1050 may determine whether the shallow group count is less than a minimum level. If so, the platform driver 1050 will cause the core to enter the shallow sleep mode (instead of the deep sleep mode selected by the governor 1040). Otherwise, if the shallow group count is not less than the minimum level, the platform driver 1050 will cause the core to enter the deep sleep mode (as selected by the governor 1040). The changes to the modes of the cores may be updated in the core status structure 1060.

In some embodiments, when a core needs to be activated (e.g., to process an upcoming workload), the scheduler 1020 determines whether any cores are currently in the shallow sleep mode. If so, the scheduler 1020 selects a core in the shallow sleep mode and causes that core to enter the active mode. Otherwise, if it is determined that there are no cores that are currently in the shallow sleep mode, the scheduler 1020 selects a core in the deep sleep mode and causes that core to enter the active mode.

The platform driver 1050 then determines whether the shallow group count is below a minimum level. If so, the platform driver 1050 transitions one or more cores from the deep sleep mode to the shallow sleep mode. The changes to the modes of the cores may be updated in the core status structure 1060.

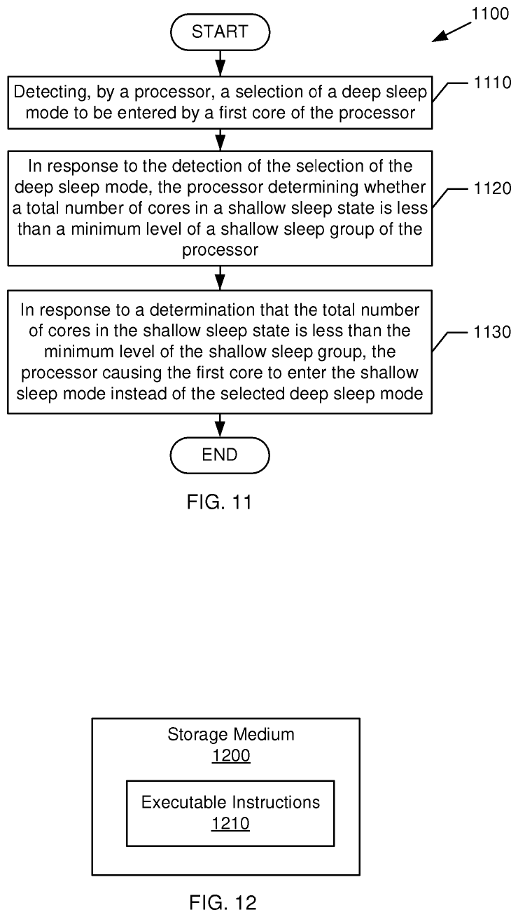

### FIG. 11—Example Method

FIG. 11 shows a flow diagram of an example method 1100 for controlling sleep modes, in accordance with one or more embodiments. In various embodiments, the method 1100 may be performed by processing logic that may include hardware (e.g., processing device, circuitry, dedicated logic, programmable logic, microcode, etc.), software (e.g., instructions run on a processing device), or a combination thereof. For example, the method 1100 may be performed by the core grouping instructions 670 (shown in FIG. 6A), by the core grouping circuitry 680 (shown in FIG. 6B), and so forth. In firmware or software embodiments, the method 1100 may be implemented by computer executed instructions stored in a non-transitory machine readable medium, such as an optical, semiconductor, or magnetic storage device. The machine-readable medium may store data, which if used by at least one machine, causes the at least one machine to fabricate at least one integrated circuit to perform a method. For the sake of illustration, the actions involved in the method 1100 may be described below with reference to FIGS. 6A-7B, which show examples in accordance with one or more embodiments. However, the scope of the various embodiments discussed herein is not limited in this regard.

Block 1110 may include detecting, by a processor, a selection of a deep sleep mode to be entered by a first core of the processor. Block 1120 may include, in response to the detection of the selection of the deep sleep mode, the processor determining whether a total number of cores in a shallow sleep state is less than a minimum level of a shallow sleep group of the processor. Block 1130 may include, in response to a determination that the total number of cores in the shallow sleep state is less than the minimum level of the shallow sleep group, the processor causing the first core to enter the shallow sleep mode instead of the selected deep sleep mode.

For example, referring to FIGS. 6A and 7A, the system software 660 (including core grouping instructions 670) determines that a deep sleep mode is selected to be entered by a core 650, and in response determines whether the shallow group count (i.e., the number of cores 650 in the shallow sleep group 720) is less than a minimum level that is predefined for the shallow sleep group 720. If the shallow group count is less than the minimum level, then the system software 660 causes the core 650A to transition from the active mode to the shallow sleep mode (i.e., instead of the selected deep sleep mode), and updates the core status structure 675 to indicate that the core 650A is transferred 745 from the active group 710 to the shallow sleep group 720.

### FIG. 12—Example Storage Medium

Referring now to FIG. 12, shown is a storage medium 1200 storing executable instructions 1210. In some embodiments, the storage medium 1200 may be a non-transitory machine-readable medium, such as an optical medium, a semiconductor, a magnetic storage device, and so forth. The executable instructions 1210 may be executable by a processing device to perform the methods shown in FIGS. 8-11. Further, the executable instructions 1210 may be used by at least one machine to fabricate at least one integrated circuit to perform the methods shown in FIGS. 8-11.

The following clauses and/or examples pertain to further embodiments.

In Example 1, a processor may include a plurality of cores and control circuitry. The control circuitry is to: detect a selection of a deep sleep mode to be entered by a first core of the processor; in response to the detection of the selection of the deep sleep mode, determine whether a total number of cores in a shallow sleep state is less than a minimum level of a shallow sleep group of the processor; and in response to a determination that the total number of cores in the shallow sleep state is less than the minimum level of the shallow sleep group, cause the first core to enter the shallow sleep mode instead of the selected deep sleep mode.

In Example 2, the subject matter of Example 1 may optionally include that the control circuitry is to, in response to the determination that the total number of cores in the shallow sleep state is less than the minimum level of the shallow sleep group, update a core status structure to indicate that the first core is transferred from an active group to the shallow sleep group.

In Example 3, the subject matter of Examples 1-2 may optionally include that the core status structure is to identify allocations of the plurality of cores to a plurality of groups, and that the plurality of groups comprises the active group, the shallow sleep group, and a deep sleep group.

In Example 4, the subject matter of Examples 1-3 may optionally include that the control circuitry is to, in response to a determination that the total number of cores in the shallow sleep state is not less than the minimum level of the shallow sleep group, cause the first core to enter the selected deep sleep mode.

In Example 5, the subject matter of Examples 1~4 may optionally include that the control circuitry is to: detect a selection of the shallow sleep mode to be entered by a second core of the processor; and in response to the detection of the selection of the shallow sleep mode, cause the second core to enter the shallow sleep mode.

In Example 6, the subject matter of Examples 1-5 may optionally include that the control circuitry is to: detect a requirement for a new active core; in response to a detection of the requirement, determine whether any core is currently in the shallow sleep mode; and in response to a determination that a third core is currently in the shallow sleep mode, cause the third core to transition from the shallow sleep mode to an active mode.

In Example 7, the subject matter of Examples 1-6 may optionally include that the control circuitry is to: after causing the third core to transition from the shallow sleep mode to an active mode, determine whether the total number of cores in the shallow sleep state is less than the minimum level of the shallow sleep group; and in response to a determination that the total number of cores in the shallow sleep state is less than the minimum level of the shallow sleep group, cause at least one core to transition from the deep sleep mode to the shallow sleep mode.

In Example 8, the subject matter of Examples 1-7 may optionally include that the control circuitry is to, in response to a determination that no cores are currently in the shallow sleep mode, cause a fourth core to transition from the deep sleep mode to the active mode.

In Example 9, a method may include: detecting, by a processor comprising a plurality of cores, a selection of a deep sleep mode to be entered by a first core of the processor; in response to the detection of the selection of the deep sleep mode, determining, by the processor, whether a total number of cores in a shallow sleep state is less than a minimum level of a shallow sleep group of the processor; and in response to a determination that the total number of cores in the shallow sleep state is less than the minimum level of the shallow sleep group, causing, by the processor, the first core to enter the shallow sleep mode instead of the selected deep sleep mode.

In Example 10, the subject matter of Example 9 may optionally include, in response to the determination that the total number of cores in the shallow sleep state is less than the minimum level of the shallow sleep group, updating a core status structure to indicate that the first core is transferred from an active group to the shallow sleep group.

In Example 11, the subject matter of Examples 9-10 may optionally include that the core status structure is to identify allocations of the plurality of cores to a plurality of groups, and that the plurality of groups comprises the active group, the shallow sleep group, and a deep sleep group.

In Example 12, the subject matter of Examples 9-11 may optionally include: in response to a determination that the total number of cores in the shallow sleep state is not less than the minimum level of the shallow sleep group, causing the first core to enter the selected deep sleep mode.

In Example 13, the subject matter of Examples 9-12 may optionally include: detecting a selection of the shallow sleep mode to be entered by a second core of the processor; and in response to the detection of the selection of the shallow sleep mode, causing the second core to enter the shallow sleep mode.

In Example 14, the subject matter of Examples 9-13 may optionally include: detecting a requirement for a new active core; in response to a detection of the requirement, determining whether any core is currently in the shallow sleep mode; and in response to a determination that a third core is currently in the shallow sleep mode, causing the third core to transition from the shallow sleep mode to an active mode.

In Example 15, the subject matter of Examples 9-14 may optionally include: after causing the third core to transition from the shallow sleep mode to an active mode, determining whether the total number of cores in the shallow sleep state is less than the minimum level of the shallow sleep group; and in response to a determination that the total number of cores in the shallow sleep state is less than the minimum level of the shallow sleep group, causing at least one core to transition from the deep sleep mode to the shallow sleep mode.

In Example 16, a computing device may include: one or more processors; and a memory having stored therein a plurality of instructions that when executed by the one or more processors, cause the computing device to perform the method of any of Examples 9 to 15.

In Example 17, at least one machine-readable medium may have stored thereon data which, if used by at least one machine, causes the at least one machine to perform the method of any of Examples 9 to 15.

In Example 18, an electronic device may include means for performing the method of any of Examples 9 to 15.

In Example 20, a system may include a processor comprising a plurality of cores, and a memory coupled to the processor. The processor is to: detect a selection of a deep sleep mode to be entered by a first core of the processor; in response to the detection of the selection of the deep sleep mode, determine whether a total number of cores in a shallow sleep state is less than a minimum level of a shallow sleep group of the processor; and in response to a determination that the total number of cores in the shallow sleep state is less than the minimum level of the shallow sleep group, cause the first core to enter the shallow sleep mode instead of the selected deep sleep mode.

In Example 21, the subject matter of Example 20 may optionally include that the processor is to, in response to the determination that the total number of cores in the shallow sleep state is less than the minimum level of the shallow sleep group, update a core status structure to indicate that the first core is transferred from an active group to the shallow sleep group.

In Example 22, the subject matter of Examples 20-21 may optionally include that the core status structure is to identify allocations of the plurality of cores to a plurality of groups, and that the plurality of groups comprises the active group, the shallow sleep group, and a deep sleep group.

In Example 23, the subject matter of Examples 20-22 may optionally include that the processor is to: detect a requirement for a new active core; in response to a detection of the requirement, determine whether any core is currently in the shallow sleep mode; and in response to a determination that a third core is currently in the shallow sleep mode, cause the third core to transition from the shallow sleep mode to an active mode.

In Example 24, the subject matter of Examples 20-23 may optionally include that the processor is to: after causing the third core to transition from the shallow sleep mode to an active mode, determine whether the total number of cores in the shallow sleep state is less than the minimum level of the shallow sleep group; and in response to a determination that the total number of cores in the shallow sleep state is less than the minimum level of the shallow sleep group, cause at least one core to transition from the deep sleep mode to the shallow sleep mode.

In Example 25, an apparatus may include: means for detecting a selection of a deep sleep mode to be entered by a first core of a processor; means for, in response to the detection of the selection of the deep sleep mode, determining whether a total number of cores in a shallow sleep state is less than a minimum level of a shallow sleep group of the processor; and means for, in response to a determination that the total number of cores in the shallow sleep state is less than the minimum level of the shallow sleep group, causing the first core to enter the shallow sleep mode instead of the selected deep sleep mode.

In Example 26, the subject matter of Example 25 may optionally include means for, in response to the determination that the total number of cores in the shallow sleep state is less than the minimum level of the shallow sleep group, updating a core status structure to indicate that the first core is transferred from an active group to the shallow sleep group.

In Example 27, the subject matter of Examples 25-26 may optionally include that the core status structure is to identify allocations of the plurality of cores to a plurality of groups, and that the plurality of groups comprises the active group, the shallow sleep group, and a deep sleep group.

In Example 28, the subject matter of Examples 25-27 may optionally include means for, in response to a determination that the total number of cores in the shallow sleep state is not less than the minimum level of the shallow sleep group, causing the first core to enter the selected deep sleep mode.

In Example 29, the subject matter of Examples 25-28 may optionally include: means for detecting a selection of the shallow sleep mode to be entered by a second core of the processor; and means for, in response to the detection of the selection of the shallow sleep mode, causing the second core to enter the shallow sleep mode.

In Example 30, the subject matter of Examples 25-29 may optionally include: means for detecting a requirement for a new active core; means for, in response to a detection of the requirement, determining whether any core is currently in the shallow sleep mode; and means for, in response to a determination that a third core is currently in the shallow sleep mode, causing the third core to transition from the shallow sleep mode to an active mode.

In Example 31, the subject matter of Examples 25-30 may optionally include: means for, after causing the third core to transition from the shallow sleep mode to an active mode, determining whether the total number of cores in the shallow sleep state is less than the minimum level of the shallow sleep group; and means for, in response to a determination that the total number of cores in the shallow sleep state is less than the minimum level of the shallow sleep group, causing at least one core to transition from the deep sleep mode to the shallow sleep mode.

In Example 32, a computing device may include: a processor comprising a plurality of cores, a memory, and a machine-readable storage storing instructions. The instructions may be executable by the processor to: detect a selection of a deep sleep mode to be entered by a first core of the processor; in response to the detection of the selection of the deep sleep mode, determine whether a total number of cores in a shallow sleep state is less than a minimum level of a shallow sleep group of the processor; and in response to a determination that the total number of cores in the shallow sleep state is less than the minimum level of the shallow sleep group, cause the first core to enter the shallow sleep mode instead of the selected deep sleep mode.

In Example 33, the subject matter of Example 32 may optionally include instructions executable by the processor to, in response to the determination that the total number of cores in the shallow sleep state is less than the minimum level of the shallow sleep group, update a core status structure to indicate that the first core is transferred from an active group to the shallow sleep group.

In Example 34, the subject matter of Examples 32-33 may optionally include that the core status structure is to identify allocations of the plurality of cores to a plurality of groups, and that the plurality of groups comprises the active group, the shallow sleep group, and a deep sleep group.

In Example 35, the subject matter of Examples 32-34 may optionally include instructions executable by the processor to, in response to a determination that the total number of cores in the shallow sleep state is not less than the minimum level of the shallow sleep group, cause the first core to enter the selected deep sleep mode. In Example 36, the subject matter of Examples 32-35 may optionally include instructions executable by the processor to: detect a selection of the shallow sleep mode to be entered by a second core of the processor; and in response to the detection of the selection of the shallow sleep mode, cause the second core to enter the shallow sleep mode.

In Example 37, the subject matter of Examples 32-36 may optionally include instructions executable by the processor to: detect a requirement for a new active core; in response to a detection of the requirement, determine whether any core is currently in the shallow sleep mode; and in response to a determination that a third core is currently in the shallow sleep mode, cause the third core to transition from the shallow sleep mode to an active mode.

In Example 38, the subject matter of Examples 32-37 may optionally include instructions executable by the processor to: after causing the third core to transition from the shallow sleep mode to an active mode, determine whether the total number of cores in the shallow sleep state is less than the minimum level of the shallow sleep group; and in response to a determination that the total number of cores in the shallow sleep state is less than the minimum level of the shallow sleep group, cause at least one core to transition from the deep sleep mode to the shallow sleep mode.

Note that, while FIGS. 6A-12 illustrate various example implementations, other variations are possible. For example, it is contemplated that one or more embodiments may be implemented in the example devices and systems described with reference to FIGS. 1-5. Note that the examples shown in FIGS. 1-12 are provided for the sake of illustration, and are not intended to limit any embodiments. Specifically, while embodiments may be shown in simplified form for the sake of clarity, embodiments may include any number and/or arrangement of components. For example, it is contemplated that some embodiments may include any number of components in addition to those shown, and that different arrangement of the components shown may occur in certain implementations. Furthermore, it is contemplated that various specifics in the examples shown in FIGS. 1-12 may be used anywhere in one or more embodiments.

Understand that various combinations of the above examples are possible. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
a plurality of cores; and
control circuitry to:
detect a selection of a deep sleep mode to be entered by a first core of the processor;
in response to the detection of the selection of the deep sleep mode, determine whether a total number of cores in a shallow sleep state is less than a minimum level of a shallow sleep group of the processor; and
in response to a determination that the total number of cores in the shallow sleep state is less than the minimum level of the shallow sleep group, cause the first core to enter the shallow sleep mode instead of the selected deep sleep mode.

2. The processor of claim 1, the control circuitry to:
in response to the determination that the total number of cores in the shallow sleep state is less than the minimum level of the shallow sleep group, update a core status structure to indicate that the first core is transferred from an active group to the shallow sleep group.

3. The processor of claim 2, wherein the core status structure is to identify allocations of the plurality of cores to a plurality of groups, and wherein the plurality of groups comprises the active group, the shallow sleep group, and a deep sleep group.

4. The processor of claim 1, the control circuitry to:
in response to a determination that the total number of cores in the shallow sleep state is not less than the minimum level of the shallow sleep group, cause the first core to enter the selected deep sleep mode.

5. The processor of claim 1, the control circuitry to:
detect a selection of the shallow sleep mode to be entered by a second core of the processor; and
in response to the detection of the selection of the shallow sleep mode, cause the second core to enter the shallow sleep mode.

6. The processor of claim 1, the control circuitry to:
detect a requirement for a new active core;
in response to a detection of the requirement, determine whether any core is currently in the shallow sleep mode; and
in response to a determination that a third core is currently in the shallow sleep mode, cause the third core to transition from the shallow sleep mode to an active mode.

7. The processor of claim 6, the control circuitry to:
after causing the third core to transition from the shallow sleep mode to an active mode, determine whether the total number of cores in the shallow sleep state is less than the minimum level of the shallow sleep group; and
in response to a determination that the total number of cores in the shallow sleep state is less than the minimum level of the shallow sleep group, cause at least one core to transition from the deep sleep mode to the shallow sleep mode.

8. The processor of claim 6, the control circuitry to:
in response to a determination that no cores are currently in the shallow sleep mode, cause a fourth core to transition from the deep sleep mode to the active mode.

9. A computing device comprising:
a processor comprising a plurality of cores;
a memory; and
a machine-readable storage storing instructions, the instructions executable by the processor to:
detect a selection of a deep sleep mode to be entered by a first core of the processor;
in response to the detection of the selection of the deep sleep mode, determine whether a total number of cores in a shallow sleep state is less than a minimum level of a shallow sleep group of the processor; and
in response to a determination that the total number of cores in the shallow sleep state is less than the minimum level of the shallow sleep group, cause the first core to enter the shallow sleep mode instead of the selected deep sleep mode.

10. The computing device of claim 9, including instructions executable by the processor to:
in response to the determination that the total number of cores in the shallow sleep state is less than the minimum level of the shallow sleep group, update a core status structure to indicate that the first core is transferred from an active group to the shallow sleep group.

11. The computing device of claim 10, wherein the core status structure is to identify allocations of the plurality of cores to a plurality of groups, and wherein the plurality of groups comprises the active group, the shallow sleep group, and a deep sleep group.

12. The computing device of claim 9, including instructions executable by the processor to:
in response to a determination that the total number of cores in the shallow sleep state is not less than the minimum level of the shallow sleep group, cause the first core to enter the selected deep sleep mode.

13. The computing device of claim 9, including instructions executable by the processor to:
detect a selection of the shallow sleep mode to be entered by a second core of the processor; and
in response to the detection of the selection of the shallow sleep mode, cause the second core to enter the shallow sleep mode.

14. The computing device of claim 9, including instructions executable by the processor to:
detect a requirement for a new active core;
in response to a detection of the requirement, determine whether any core is currently in the shallow sleep mode; and
in response to a determination that a third core is currently in the shallow sleep mode, cause the third core to transition from the shallow sleep mode to an active mode.

15. The computing device of claim 14, including instructions executable by the processor to:
after causing the third core to transition from the shallow sleep mode to an active mode, determine whether the total number of cores in the shallow sleep state is less than the minimum level of the shallow sleep group; and
in response to a determination that the total number of cores in the shallow sleep state is less than the minimum level of the shallow sleep group, cause at least one core to transition from the deep sleep mode to the shallow sleep mode.

16. A system comprising:
a processor comprising a plurality of cores; and
a memory coupled to the processor,
the processor to:
detect a selection of a deep sleep mode to be entered by a first core of the processor;
in response to the detection of the selection of the deep sleep mode, determine whether a total number of cores in a shallow sleep state is less than a minimum level of a shallow sleep group of the processor; and
in response to a determination that the total number of cores in the shallow sleep state is less than the minimum level of the shallow sleep group, cause the first core to enter the shallow sleep mode instead of the selected deep sleep mode.

17. The system of claim 16, the processor to:
in response to the determination that the total number of cores in the shallow sleep state is less than the minimum level of the shallow sleep group, update a core status structure to indicate that the first core is transferred from an active group to the shallow sleep group.

18. The system of claim 17, wherein the core status structure is to identify allocations of the plurality of cores to a plurality of groups, and wherein the plurality of groups comprises the active group, the shallow sleep group, and a deep sleep group.

19. The system of claim 16, the processor to:
detect a requirement for a new active core;
in response to a detection of the requirement, determine whether any core is currently in the shallow sleep mode; and
in response to a determination that a third core is currently in the shallow sleep mode, cause the third core to transition from the shallow sleep mode to an active mode.

20. The system of claim 19, the processor to:
after causing the third core to transition from the shallow sleep mode to an active mode, determine whether the total number of cores in the shallow sleep state is less than the minimum level of the shallow sleep group; and
in response to a determination that the total number of cores in the shallow sleep state is less than the minimum level of the shallow sleep group, cause at least one core to transition from the deep sleep mode to the shallow sleep mode.
